(19) United States
(12) Patent Application Publication
(10) Pub. No.: US 2015/0153232 A1
(43) Pub. Date: Jun. 4, 2015

(54) MICROSCOPE WITH DETECTOR STOP MATCHING

(71) Applicant: Checkpoint Technologies LLC, San Jose, CA (US)

(72) Inventor: Guoqing Xiao, Saratoga, CA (US)

(73) Assignee: Checkpoint Technologies LLC, San Jose, CA (US)

(21) Appl. No.: 14/094,547

(22) Filed: Dec. 2, 2013

(51) Int. Cl. G01J 5/02; G02B 21/36; G02B 21/02; G01J 5/10; G01N 21/88

(52) U.S. Cl. CPC G01J 5/0205; G01J 5/10; G01N 21/8851; G02B 21/02; G02B 21/025; G02B 21/361; G01J 2005/106; G01N 2201/023

(57) ABSTRACT

A microscope includes a detector device having an enclosure and an infrared sensitive detector array disposed within the enclosure. The enclosure may be cryogenically cooled and have an aperture which defines an aperture stop for an optical path extending to the detector array. The microscope may have a microscope objective with an objective exit pupil, and the microscope may include one or more intermediate optical elements which are configured to image at least a portion of the objective exit pupil at the aperture stop while simultaneously focusing light from an object transmitted through the objective at the detector array.

### FIELD

The present disclosure relates to microscopy. In particular, aspects of the present disclosure relate to infrared sensitive emission microscopes useful for failure analysis of integrated circuits and other electronic devices.

### BACKGROUND

Emission microscopy, sometimes referred to as photon emission microscopy (PEM) or light emission microscopy (LEM), has developed into a useful tool for non-invasive failure analysis, particularly in the semiconductor industry as a tool to localize and characterize defects in integrated circuits (ICs) and other electronic devices. These techniques traditionally rely on known photoemission characteristics of circuit features and defect sites in the visible and infrared wavelengths during operation of the device. An emission microscope having a camera sensitive to the light in the emitted spectra, typically in the visible and/or infrared wavelengths, is used to capture magnified images of the sample, e.g. the powered on device.

As computing keeps shifting to smaller battery powered mobile devices, including smart phones and wearable devices such as smart watches and augmented reality glasses, reducing power consumption has become a primary concern among IC chip manufacturers. Accordingly, with chip operating voltages and circuit feature sizes continuing to shrink, presently down to below one volt and tens of nanometers, respectively, the amount of photons emitted by each device has dropped to such a level that it has become very difficult and it takes very long to form a meaningful image for analysis of the device. Worse, the device emissions shift to longer wavelengths, e.g. the short wave infrared (SWIR) range or longer, where blackbody radiation becomes a more dominant source of image background noise.

In order to minimize sensor noise and reduce undesired blackbody radiation in the image, conventional emission microscopes typically enclose a focal plane array (FPA) of the camera in a cooled enclosure, such as a liquid nitrogen cooled Dewar. A small opening is included in the enclosure to ideally allow only the emitted photons from the sample to reach the focal plane array at the back of the camera for detection of the desired image. Unfortunately, conventional emission microscope designs are poorly equipped for blackbody radiation rejection, resulting in the relevant defect emissions of interest being swamped by blackbody radiation in images of the devices being analyzed.

It is within this context that the present disclosure arises.

### SUMMARY

According to aspects of the present disclosure, a microscope may include a detector device having an enclosure and an infrared sensitive detector array disposed within the enclosure, the enclosure having an aperture which defines an aperture stop for an optical path extending to the detector array; a microscope objective having one or more objective optical elements, the one or more objective optical elements having an objective exit pupil; and one or more intermediate optical elements, wherein the one or more intermediate optical elements are configured to image at least a portion of the objective exit pupil at the aperture stop while simultaneously focusing light from an object transmitted through the objective at the detector array.

### BRIEF DESCRIPTION OF THE DRAWINGS

The teachings of the present disclosure can be readily understood by considering the following detailed description in conjunction with the accompanying drawings, in which:

FIG. 1 is a schematic illustration of a conventional emission microscope.

FIG. 2 is a schematic illustration of an emission microscope according to various implementations of the present disclosure.

### DETAILED DESCRIPTION

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

It is noted that various directional terminology is used herein with reference to optical systems. As used herein, directional terminology is used with reference to the optical path defined by an optical system. Thus, directional terminology such as “front”, “back”, “forward”, and “behind”, refer to the direction of propagation of light defined by the design of the system.

### Introduction

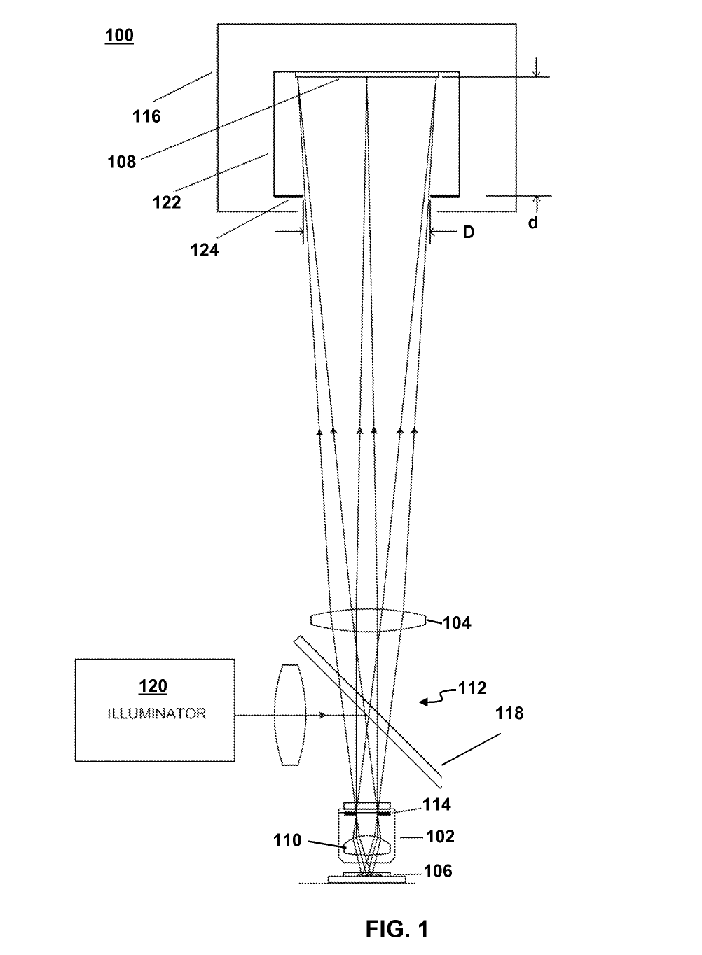

In order to illustrate various aspects of the present disclosure, a schematic illustration of a conventional emission microscope 100 is first depicted in FIG. 1.

The conventional microscope 100 includes an objective 102 and a tube lens 104 which are collectively configured to image the sample 106 being analyzed onto a focal plane array (FPA) 108, with a degree of magnification determined by the optics of the system 100. In particular, the objective 102 has one or more objective optical elements 110 (e.g., lenses) configured to transmit light rays received from the sample 106 towards the tube lens 104, with the amount of magnification in the resulting image primarily determined by tube lens 104 and the objective 102, which may have a very short focal length for magnification of objects placed close to and in front of the objective. The light transmitted by the objective 102 passes through the objective exit pupil 114, at the rear or image side of the objective lens 110. The exit pupil 114 may be a physical aperture located at the back focal plane of the objective 102 or at another location inside or near the objective.

In the example conventional microscope 100 depicted in FIG. 1, the optics are designed so that the objective 102 transmits a parallel flux of light rays 112 towards the tube lens 104, i.e. it images the sample 106 at infinity with a high degree of magnification, and the tube lens is configured to focus the parallel path of rays 112 onto the focal plane array 108 so that the magnified image may be captured by the camera 116. In other words, the microscope 100 may be designed so that the focal plane array 108 is disposed an axial distance away from the tube lens 104 approximately equal to the effective focal length of the tube lens 104. Likewise, the image detected by the camera 116 is configured to be in focus when the sample 106 being analyzed is placed at an axial distance away from the objective optical elements 110 approximately equal to its effective focal length, although the microscope may include certain mechanical adjustments in order to fine tune the focus by modifying the relative axial positions of certain microscope components.

In alternative implementations, the objective optical elements 110 may form an image directly onto the focal plane array 108, which is disposed a finite axial distance away from the objective 102 and the tube lens 104 may be omitted.

It is noted that the term “objective optical elements” is used herein to distinguish optical elements, e.g., lenses, mirrors, prisms, apertures, filters, that are part of the objective 102 from other optical elements used in the microscope 100.

As a result of this setup, certain benefits may be realized by the parallel path of light 112, i.e. by having the optical elements 110 focus the image of the sample 106 at infinity. For example, various components of the device may be disposed in the parallel path of light 112 between the objective 102 and the tube lens 104 with no or only a minimal effect on focus. In the conventional microscope 100 depicted in FIG. 1, a beam splitter 118, e.g. a pellicle, may be placed in the parallel path of light 112 in coordination with an illumination source 120 in order to initially illuminate the sample with visible light in order to facilitate alignment and focus of the sample 106. It is noted that other conventional microscopes similar to the microscope 100 depicted in FIG. 1 may instead use a finite objective, wherein the magnified image transmitted through the objective exit pupil 114 is focused a finite distance away by the objective optics 110, although infinite objectives such as that depicted in FIG. 1 may be preferable in certain instances. Regardless, the design of the microscope necessitates that the objective 102 be placed a significant distance away from the image capture device 116.

In order to capture the image signal, the focal plane array 108 of the camera 116 includes an array of detector elements which are sensitive to infrared radiation of the desired wavelengths in order to detect emissions useful in characterizing the sample 106. For example, the sample 106 may be an integrated circuit being analyzed for certain device failures, and the focal plane array 108 may include an array of detector elements which are sensitive to light in the infrared spectrum that is emitted by certain faults in the device, e.g. photons with wavelengths corresponding to the energy released in electron-hole recombinations occurring at defect sites when a sample device is powered on.

In order to minimize sensor noise and reject blackbody radiation (sometimes referred to as “thermal noise”) which could overwhelm the desired emission signal from the sample 106, the focal plane array 108 of the system 100 is disposed at the back of an enclosure 122 which is cryogenically cooled to provide a cold environment for the detector array 108 and surrounding area. The cooled enclosure 122 includes a small aperture 124 having a diameter D that is sized to correspond to the spread of photons emitted from the sample 106 and transmitted through the tube lens 104, thus attempting to maximize detection of the emission signal while minimizing detection of other radiation which is not relevant to the analysis. Furthermore, as shown in FIG. 1, the focal plane array 108 is generally disposed at the back of the enclosure 122 at an axial distance d away from the aperture, or “cold stop” 124, and this focal plane array 108 is disposed in the optical pathway defined by the microscope optics 102,104 and camera cold stop 124.

As can be seen in FIG. 1, the cold stop 124 of the camera 116 is poorly matched to the exit pupil 114 of the objective 102 due to separation therebetween, which is necessitated by the microscope design and the need to insert various system components in the optical pathway which extends between the camera 116 and the objective 102, such as a beam splitter 118, tube lens 104, and the like. As a result, the diameter D of the cold stop 124 is relatively large in order to allow all the photons emitted from the sample 106 to reach the focal plane array 108 for detection of the magnified image. Unfortunately, this large opening also allows a significant amount of undesired blackbody radiation from various objects to reach the detector array 108, and the minimization of this thermal noise is especially critical when attempting to capture a meaningful image of devices which emit in longer infrared wavelengths approaching that of the blackbody radiation.

It is noted that the noise in the signal detected by the sensor array 108 that is attributable to blackbody radiation may be described as being approximately proportional to a ratio D²/d², the size D of the cold stop aperture 124 to the axial distance d between the focal plane array 108 and this aperture 124. In other words, for the conventional microscope 100 depicted in FIG. 1, the blackbody noise is approximately proportional to the solid angle subtended by the camera aperture 124 at the focal plane array 108. Moreover, this ratio D²/d² is essentially constrained by the need of the tube lens 104 to focus the image onto the focal plane array 108, thereby minimizing the flexibility with which the dimensions D and d may be modified while still imaging the emitted photons at the focal plane array.

### Solution to the Problem

To address the aforementioned drawbacks associated with conventional emission microscopes, various implementations of the present disclosure may include intermediate optics which better match the exit pupil of an objective to an aperture stop of a detector device.

For example, the aperture stop which restricts the amount of light may be located behind optics in the image space of the objective. In this case, the exit pupil coincides with the aperture stop, and the exit pupil is an actual aperture of the system. In yet further implementations, the aperture stop may be located in an intermediate space between individual optical elements of the objective optics, e.g., between lenses. Further still, none of the stops in an objective or other optical system may ultimately restrict the amount of light allowed to reach the imaging area, in which case an effective periphery, e.g. diameter, of an optical element itself may restrict the light and be construed as the aperture stop, in which case the exit pupil may be the image formed by this periphery.

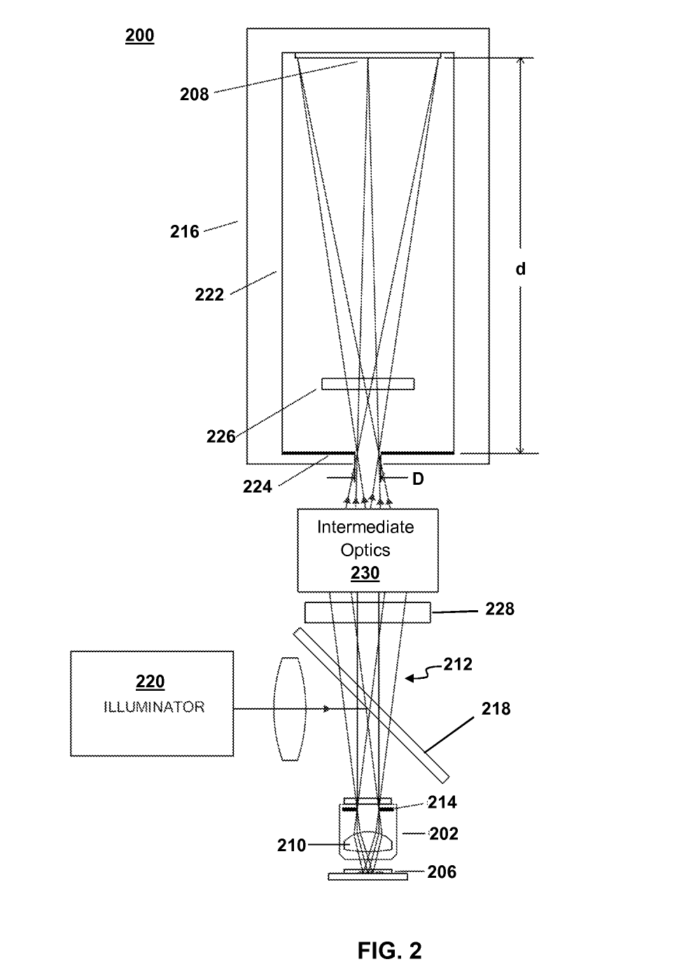

Turning now to FIG. 2, an illustrative example of an emission microscope 200 in accordance with various implementations of the present disclosure is depicted. The example microscope 200 may improve upon blackbody radiation rejection and provide images having improved signal to noise ratio as compared to conventional microscopes, such as the microscope 100 depicted in FIG. 1. In order to achieve this object, the example microscope 200 depicted in FIG. 2 may include a special set of optics located in the optical path behind the objective, and which may be designed to image at least a portion of an objective's exit pupil at the aperture stop of a detector device.

Turning to FIG. 2 in more detail, the example microscope 200 may include an objective 202 having one or more optical elements 210 which are collectively configured to collect light from a sample 206 and produce a magnified image thereof. The objective optics 210 may be made up of one or more lenses which are configured to transmit infrared light from the sample 206, through the exit pupil 214, to a set of intermediate optics 230 which focus the light from the sample onto the detector array 208.

It is noted that the term “objective optical elements” is used herein to distinguish optical elements, e.g., lenses, mirrors, prisms, apertures, filters, that are part of the objective 202 from other optical elements used elsewhere in the microscope 200.

The microscope 200 may also include one or more additional components which may be disposed in the optical path 212 which extends between the objective 202 and the intermediate optics 230. By way of example, and not by way of limitation, the microscope 200 may include an illuminator 220 which provides a source of light, e.g., visible light or infrared light, and a beam splitter 218, e.g. a pellicle, disposed in the optical pathway behind the objective 202, configured to provide illumination of the sample 206 under analysis. This may be useful during an initial step of aligning and focusing the sample under illumination, after which the illuminator may be turned off and the photons emitted from the sample may be collected. In various implementations, the beam splitter 218 and/or the illuminator 220 may be movable out of this optical path behind the objective so that, after aligning and/or focusing the sample, the amount of useful light that is collected from the output of the objective is optimized.

The example microscope 200 also includes a detector device 216 in order to capture a signal corresponding to the magnified image of the sample. The detector device 216 may include an enclosure 222, with an infrared sensitive detector array 208 disposed within the enclosure, and a small opening 224 defining an aperture stop for the detector device 216 may be included in the enclosure to allow some or all of the emitted photons from the sample through to the detector array 208. The infrared sensitive array 208 may be disposed in the back of the enclosure 222 and the enclosure may be cooled during operation in order to reduce sensor noise and reject blackbody radiation. By way of example, and not by way limitation, the enclosure 222 may be a Dewar having two or more layers with a vacuum maintained between the layers so that cryogenic temperatures within the enclosure, e.g. temperatures around 77 Kelvin, may be more easily maintained, and the enclosure 222 may be cooled during operation using liquid nitrogen or some other cooling technique.

As shown in FIG. 2, and in contrast to conventional microscopes, the intermediate optics 230 may include one or more optical elements which are designed to image the objective exit pupil 214 at the detector aperture stop, i.e. the opening in the enclosure 222 in the example of FIG. 2. For example, the intermediate optics 230 may include one or more lenses which are configured to relay the exit pupil image to a plane defined by the aperture stop 224 of the detector device. In addition, the intermediate optics 230 may also be configured to simultaneously focus the magnified image of the objective magnification target, e.g. the sample 206, at the detector array 208.

As a result of the above design, the intermediate optics 230 may replace a conventional tube lens, such as is depicted in FIG. 1, by focusing the photons emitted from the objective magnification target 206 at the detector array 208, while simultaneously providing the ability to reduce thermal noise by matching the cold stop 224 of the detector device 216 to the exit pupil 214 of the objective by relaying the exit pupil image to the plane of the cold stop 224. This may allow the cold enclosure to be better designed to achieve optimal rejection of blackbody radiation that would otherwise reach the detector array 208.

For example, as shown in the FIG. 2, the aperture stop 224 of the cold enclosure 222 may have a diameter D and the detector array 208 may be disposed at the back of the space within the enclosure 222 at an axial distance d away from the stop 224. As noted above, the amount of noise in the detected signal image which is attributable to blackbody radiation is approximately proportional to the ratio D²/d². As shown in FIG. 2, reduction of this ratio may be achieved and a smaller size opening relative to its axial distance from the detector array may be used, without having to reduce the detection of the photons emitted from the sample 206, due to the matching of the exit pupil 214 to this entrance aperture 224 of the detector device 216. It is noted that because a substantial portion of the blackbody noise in the signal reaches the detector array through the opening 224 of the enclosure, which is needed to allow the desired signal through, these optimizations may minimize the path for undesired blackbody rays to reach the detector array while maintaining the ability of the detector array to capture all, or a substantial portion, of the light emitted from the sample 206 and as focused by the intermediate relay optics 230.

In some embodiments, an optical filter 226 may be located within the cold enclosure 222 to filter out certain bands of the black body radiation spectrum. For example, if the emission of interest is only in a wavelength range up to some cutoff wavelength, the filter 226 may be a low pass filter that passes radiation having vacuum wavelengths below the cutoff. In some implementations, the optical filter 226 may include multiple different filter elements for different wavelength ranges that can be selectively moved in and out of the optical path.

In some embodiments, the microscope 200 may optionally include polarization control optics 228. By way of example, in FIG. 2, the polarization control optics 228 are located between the beamsplitter 218 and the relay optics 230. Alternatively, the polarization control optics may be located between the relay optics and the cold stop 224 or between the objective 202 and the beamsplitter 218. The polarization control optics 228 are useful to image structures in the sample that have repeating features that are aligned in a particular direction. By way of example, the polarization control optics 228 may include one or more linear polarizers or one or more radial polarizers. The polarization control optics 228 may be mounted to a mechanism that allows them to slide into or out of the beam path. The mechanism may also be configured to rotate the polarization control optics to change the polarization of light transmitted to the cold stop 224.

It is noted that various parameters of the example microscope 200 depicted in FIG. 2 may be modified while still providing a substantial benefit over conventional microscopes. For example, it is noted that in the illustration of FIG. 2, the example exit pupil 214 and the example cold stop 224 are precisely matched with 1:1 correspondence, i.e. the image of the exit pupil is relayed to the aperture stop 1:1, without any magnification, and the size of the entrance pupil (i.e. the aperture stop) for the detector device is the same as the exit pupil of the objective. This may present an optimum scenario, in which the opening is sized to let just the emitted photons in and no more, maximizing the capture of emitted photons from the sample while minimizing detection of thermal noise; however, it is noted this such exact matching is not strictly necessary, and that this scenario may be modified according to various practical considerations without departing from the scope and spirit of the present disclosure. The ratio of exit pupil size to cold stop aperture size may be greater than 1:1, e.g., up to 2:1; or less than 1:1, e.g., down to 1:2 or down to 1:5.

For example, for practical consideration, it may be desirable to make the diameter of the camera cold stop slightly larger than the diameter of the objective exit pupil in order to account for manufacturing tolerances and slight alignment errors. In one example, the diameter of the objective exit pupil may be 3.8 millimeters (mm), while cold stop may be 4 mm in order to account for these manufacturing considerations.

By way of further example, in some implementations it may be desirable to image the exit pupil of the objective at the aperture stop of the detector device with some degree of magnification, e.g. 1:2 magnification, 1:5 magnification, 1:10 magnification, some other degree of magnification. For example, due to manufacturing tolerances, there may be some small amount of misalignment between the optical axis of the objective 202 and the cold stop aperture 224 when attempting to construct the microscope 200. Magnifying the image of the exit pupil relayed by the intermediate optics 230 and enlarging diameter D of the cold stop 224 accordingly may minimize the effect of such misalignment, e.g. because a given amount of misalignment will become a smaller percentage of the overall image being transmitted through to the detector array. The detector array 208 may be placed further back (i.e. distance d may be increased) proportionally in relation to the increased cold stop diameter to preserve the benefits of improved blackbody radiation rejection and maintain focus of the magnified image of the objective target 206.

Furthermore, it is noted that while a single objective is depicted in the schematic diagram of FIG. 2, the system 200 may actually include a plurality of objectives which are each attached to a movable mount, such as a rotatable turret, and which may provide a different degree of magnification to allow the desired objective to be easily selected by a user of the microscope. Likewise, the movable mount may be configured to allow the attached objectives to be easily replaced as desired, and the microscope 200 may otherwise be configured to operate using different microscope objectives.

It is noted that different objectives may have different exit pupils depending on their design, resulting in the optimal camera cold stop size which matches the image of the exit pupil to be dependent on the particular objective used in the system 200. In order to account for this dependence on the parameters of the objective, in some implementations the enclosure may include an adjustable aperture stop that allows its diameter to be readily changed. For example, the enclosure 222 may include an adjustable iris to allow the aperture stop diameter to be readily changed to match the particular objective used. Alternatively, an adjustable aperture stop may be implemented that includes a set of selectable apertures from which an aperture of a given aperture size can be inserted into the optical path of the system, e.g., using a rotatable wheel with different sized apertures.

In yet further implementations, it may be desirable to minimize the complexity of the microscope 200 and the enclosure design by using a cold stop aperture 224 in the enclosure 222. However, it would be desirable to still accommodate different objectives 202 which may each have different sized exit pupils being relayed to the fixed size aperture stop 224. Accordingly, the enclosure 222 may utilize a fixed size aperture stop which is sized according to the size of the exit pupil image relayed by the intermediate optics 230 based on the exit pupil size of one or more of the multiple objectives. By way of example, the size of the aperture stop may be the same size as the smallest objective exit pupil for 1:1 relay, or may be proportional to the magnification. Accordingly, when an objective having a larger exit pupil is selected, the exit pupil as imaged at the aperture stop may be slightly larger, and the resulting images captured by the detector array may have reduced intensity or reduced resolution because the periphery of the light allowed to pass through the detector aperture would be blocked.

It is noted that the microscope 200 may be designed so that a magnified image of a sample is produced at the detector array 208 when the sample is placed at an axial distance from the objective optics that is equivalent to its effective focal length. As shown in FIG. 2, this results in a parallel path of light 212 propagating through the objective exit pupil 214 to the intermediate optics 230. In alternative implementations of the example microscope 200 depicted in FIG. 2, the objective 202 and remaining microscope optics may be designed for a finite objective having a converging flux of light rays in the image space of the objective 202.

In some preferred implementations, the objectives may include a high refractive index material in the object space of the objective optics, such as with a solid immersion lens (SIL) objective, in order to provide a higher resolution and/or a higher degree of magnification than would otherwise be possible. This is particularly useful in imaging small scale circuit features in a semiconductor device. By way of example, and not by way of limitation, each of the one or more objectives may have an effective focal length between 0.2 mm and 40 mm, and a plurality of these objectives with different focal lengths within this range may be attached to the objective mount to allow user selection of objectives with different degrees of magnification.

In various implementations, the detector elements may be sensitive to infrared light at the particular wavelengths of interest for a desired application. In some preferred implementations, the detector array is sensitive to an infrared spectrum falling within a range defined by the near-infrared (NIR), short-wavelength infrared (SWIR), and mid-wavelength infrared (MWIR) wavelengths. For example, in some implementations the detector array may be sensitive to infrared radiation characterized by a vacuum wavelength ranging from about 1.2 microns to about 2.5 microns, where blackbody radiation typically overwhelms the desired emission signal from an IC device. By way of example, and not by way of limitation, the detector array may be made of mercury cadmium telluride (HgCdTe), indium gallium arsenide (InGaAs), or another suitable type, which may be tuned to detect the desired wavelengths of interest.

In some implementations, the microscope may also include one or more filters to further filter out certain wavelengths, such as blackbody radiation that is outside of the samples emission wavelengths of interest. For example, one or more bandpass filters may be included in the enclosure, e.g. a plurality of filters on a filter wheel which allows a one of the filters to be selected, and the bandpass of the one or more filters may be selected to allow the desired infrared wavelength through to the detector array.

It is noted that while various implementations of the present disclosure have been described with reference to lenses as the primary optical elements, it is possible to use various other optical elements in place thereof, such as mirrors, without departing from the spirit and scope of the present disclosure.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “a”, or “an” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A microscope comprising:
a detector device having an enclosure and an infrared sensitive detector array disposed within the enclosure, the enclosure having an aperture which defines an aperture stop for an optical path extending to the detector array;
a microscope objective having one or more objective optical elements, the one or more objective optical elements having an objective exit pupil; and
one or more intermediate optical elements,
wherein the one or more intermediate optical elements are configured to image at least a portion of the objective exit pupil at the aperture stop while simultaneously focusing light from an object transmitted through the objective at the detector array.

2. The microscope of claim 1, wherein the microscope objective is a solid immersion lens.

3. The microscope of claim 1, further comprising one or more polarization control optics disposed between the aperture and the objective.

4. The microscope of claim 3, wherein the polarization control optics include one or more linear polarizers.

5. The microscope of claim 4, wherein the one or more linear polarizers are configured to rotate to adjust a polarization of light transmitted to the aperture.

6. The microscope of claim 1,
wherein a diameter of the exit pupil of the objective is approximately equal to a diameter of the aperture stop.

7. The microscope of claim 1,
wherein a diameter of the objective exit pupil is less than a diameter of the aperture stop, and
wherein the one or more intermediate optical elements are configured to image the objective exit pupil with a degree of magnification corresponding to a ratio of the diameter of the objective exit pupil to the diameter of the aperture stop.

8. The microscope of claim 1,
wherein a diameter of the image of the objective exit pupil imaged by the intermediate optical elements is larger than a diameter of the aperture stop.

9. The microscope of claim 1,
wherein the enclosure is a Dewar having plurality of layers with a vacuum maintained therebetween.

10. The microscope of claim 1,
wherein the enclosure is cryogenically cooled.

11. The microscope of claim 1,
wherein the enclosure is a Dewar having plurality of layers with a vacuum maintained therebetween,
wherein the enclosure is cryogenically cooled using liquid nitrogen.

12. The microscope of claim 1,
wherein the detector array is a focal plane array sensitive to light which falls within the short wavelength infrared spectrum.

13. The microscope of claim 1, further comprising one or more additional microscope objectives,
wherein each said objective is configured to magnify the object with a different degree of magnification, and
wherein all of said objectives are attached to a movable objective mount.

14. The microscope of claim 1, further comprising one or more additional microscope objectives,
wherein each said objective is configured to magnify the object with a different degree of magnification,
wherein all of said objectives are attached to a movable objective mount,
wherein said movable objective mount is rotatable turret.

15. The microscope of claim 1, further comprising:
an illuminator configured emit visible light, and
a beam splitter, wherein the beam splitter is disposed between the objective and the one or more intermediate optical elements.

16. The microscope of claim 1, wherein the one or more intermediate optical elements include a plurality of relay lenses.

17. The microscope of claim 1, further comprising an optical filter disposed within the enclosure between the aperture and the detector array.

18. The microscope of claim 1, wherein the aperture is an adjustable diameter aperture.

19. The microscope of claim 18, wherein the adjustable diameter aperture includes a plurality of apertures from which an aperture of a given size is selectable.

20. The microscope of claim 1, wherein the enclosure is configured to maintain the aperture at a colder temperature than the exit pupil.

21. A microscope comprising:
a detector device having an enclosure and an infrared sensitive detector array disposed within the enclosure, wherein the enclosure has an aperture which defines an aperture stop for an optical path extending to the detector array;
an objective mount configured have a microscope objective attached thereto, the microscope objective having one or more objective optical elements, the one or more objective optical elements having an objective exit pupil; and
one or more intermediate optical elements,
wherein the one or more intermediate optical elements are configured to image at least a portion of the objective exit pupil at the aperture stop while simultaneously focusing light from an object transmitted through the objective at the detector array.

22. The microscope of claim 21, wherein the microscope objective is a solid immersion lens.

23. The microscope of claim 21, further comprising one or more polarization control optics disposed between the aperture and the objective.

24. The microscope of claim 23, wherein the polarization control optics include one or more linear polarizers.

25. The microscope of claim 24, wherein the one or more linear polarizers are configured to rotate to adjust a polarization of light transmitted to the aperture.

26. The microscope of claim 21,
wherein the objective mount is further configured to have one or more additional microscope objectives attached thereto, and
wherein the objective mount is movable to allow selection of a one of the microscope objectives for magnification of the object.

27. The microscope of claim 21,
wherein the objective mount is further configured to have one or more additional microscope objectives attached thereto,
wherein the objective mount is movable to allow selection of a one of the microscope objectives for magnification of the object,
wherein the objective mount is a rotatable turret.

28. The microscope of claim 21, further comprising one or more objectives attached to the objective mount.

29. The microscope of claim 21,
wherein a diameter of the exit pupil of the objective is approximately equal to a diameter of the aperture stop.

30. The microscope of claim 21,
wherein the enclosure is a Dewar having plurality of layers with a vacuum maintained therebetween.

31. The microscope of claim 21,
wherein the detector array is a focal plane array sensitive to light which falls within the short wavelength infrared spectrum.

32. The microscope of claim 21, further comprising an optical filter disposed within the enclosure between the aperture and the detector array.

33. The microscope of claim 21, wherein the aperture is an adjustable diameter aperture.

34. The microscope of claim 34, wherein the adjustable diameter aperture includes a plurality of apertures from which an aperture of a given size is selectable.

35. The microscope of claim 21, wherein the enclosure is configured to maintain the aperture at a colder temperature than the exit pupil.
